(19) United States
(12) Patent Application Publication
(10) Pub. No.: US 2025/0043450 A1
(43) Pub. Date: Feb. 6, 2025

(54) Transport System for Hydrogen Gas

(71) Applicants: David James Prum, Fernandina Beach, FL (US); Gregory Joseph Opas, Fairfax, VA (US)

(72) Inventors: David James Prum, Fernandina Beach, FL (US); Gregory Joseph Opas, Fairfax, VA (US)

(21) Appl. No.: 18/717,163

(22) PCT Filed: Dec. 6, 2022
(86) PCT No.: PCT/US2022/051962

§ 371 Date: Jun. 6, 2024

Related U.S. Application Data
(60) Provisional application No. 63/286,701, filed on Dec. 7, 2021.

(51) Int. Cl. C25B 15/08; B64B 1/66; C25B 9/65; H02J 15/00

(52) U.S. Cl. CPC C25B 15/08; B64B 1/66; C25B 9/65; H02J 15/008

(57) ABSTRACT

A method includes delivering hydrogen gas from a producer of hydrogen gas to a consumer of hydrogen gas by filling an acrostat with hydrogen gas to an internal pressure at which the aerostat achieves neutral buoyancy and remains at a stable altitude and using a powered vehicle to tow the acrostat to the consumer.

### CROSS REFERENCE TO RELATED APPLICATIONS

This application claims priority to U.S. Application No. 63/286,701, filed on Dec. 7, 2021, the contents of which are hereby incorporated by reference in their entirety.

### FIELD OF INVENTION

This invention relates to transport of lighter-than-air gas and in particular to the transport of hydrogen gas.

### BACKGROUND

Hydrogen is a useful reagent for the manufacture of certain goods. For example, the manufacture of fertilizer requires copious amounts of hydrogen to combine with nitrogen to form ammonia. In addition, interest has grown in the use of hydrogen as a clean energy source.

Because hydrogen gas is so light, it easily escapes from the Earth's gravitational field. As a result, over the years, the Earth has lost most of its free hydrogen gas into space. This means that although considerable hydrogen is present on Earth, it is primarily found bound to other atoms.

Hydrocarbons provide a ready source of hydrogen gas. A particularly common method of recovering hydrogen is steam methane reforming. However, this method produces considerable amounts of carbon dioxide as a waste product. Moreover, if hydrogen is to be used as a clean energy source, the notion of extracting hydrogen by steam methane reforming would appear to negate the purpose.

Hydrogen is also present in an even more readily-available compound, namely water. However, separating hydrogen from oxygen in water is considerably more difficult. A known way to do so is to carry out electrolysis. However, electrolysis of water requires prodigious amounts of electricity. Although electricity can easily be generated by burning fossil fuels, doing so would tend to negate this advantage of electrolysis.

A solution would be to make the electricity required for electrolysis in a way that avoids burning fossil fuels. Known ways of doing so include using wind or geothermal energy as a source of energy for turning generators. This provides inexpensive electricity without significant environmental costs.

A difficulty that arises is that the distribution of wind and geothermal energy sources is not spatially homogenous. Geothermal sources are most common where the Earth's mantle is relatively thin. Wind energy is most common where wind blows more frequently, for example at offshore wind farms. These are often located at some distance from the point at which the hydrogen is to be consumed.

Although electricity can be transported to a more convenient location, doing so requires considerable infrastructure. Moreover, ohmic losses and radiative losses arise during transport. As a result, it is preferable to carry out electrolysis near the source of electricity and to transport the resulting hydrogen gas to the consumer.

A known method for transporting hydrogen gas is to first liquefy it to reduce the volume required. The liquified gas can then be placed on a conventional transport vehicle such as a cargo ship or a railroad car for transport. The reduction in volume permits a large amount of hydrogen to be carried at one time, thus rendering the practice economically viable. However, this method also requires considerable infrastructure for liquifying large amounts of hydrogen and keeping it liquid during transport.

Another method of transporting hydrogen gas would be to use a pipeline. However, doing so requires building a pipeline. While it may be tempting to repurpose existing pipelines, which are presently used for natural gas, the chemical properties of hydrogen and methane gases are different enough so that this would not be practical.

### SUMMARY

The invention contemplates a hydrogen-transport system in which a hydrogen produced from electrolysis at a remote site is used to fill a lighter-than-air vehicle, such as an aerostat, at pressures above atmospheric. As the hydrogen gas accumulates within the vessel at higher and higher pressures, the vehicle's total mass increases. Eventually, this additional mass causes the aerostat to transition from being positively buoyant to neutrally buoyant. At this point, the filling operation ceases. The aerostat, perhaps bundled together with many other similarly-filled aerostats, is then towed to its destination by a towing vehicle. The pressurized aerostats are then unloaded of their hydrogen content, deflated, folded into a more compact form, placed on board the towing vehicle, and brought back as cargo to the point-of-origin, where they can be used for another trip.

In one aspect, the invention includes delivering hydrogen gas from a producer of hydrogen gas to a consumer of hydrogen gas by filling an aerostat with a sufficient quantity of hydrogen gas pressurized above atmospheric pressure, thereby increasing total system mass such that positive buoyancy is counteracted and the system attains neutral buoyancy. The aerostat is then towed to the hydrogen-gas consumer.

Some practices further include deflating and stowing the resulting unfilled aerostat inside a towing vehicle that was used to tow the aerostat to the hydrogen-gas consumer and transporting the aerostat away from the hydrogen-gas consumer. The aerostat can be transported either back to the producer, to another producer of hydrogen gas, or to any other location.

Still other practices include folding the aerostat into a form that enables the aerostat to be carried with greater volumetric efficiency within a towing vehicle that was used to tow the aerostat to the hydrogen-gas consumer. As used herein, “volumetric efficiency” refers to the difference between the volume of the aerostat when in use for cargo transport and the volume of the aerostat when it has been loaded onto the towing vehicle.

In some practices, the aerostat is one of a plurality of identical aerostats, each of which has been brought to neutral buoyancy as a result of having been filled with hydrogen gas at pressures considerably above atmospheric pressure but well below the pressure required for liquefaction. In such practices, delivering the hydrogen gas further includes binding the aerostats together, thereby forming a bundle, and towing the aerostat, along with all the other aerostats in the bundle, to the hydrogen-gas consumer.

Further practices include those in which the aerostat or the bundle of aerostats is towed by a self-propelled aerostat, such as a dirigible or airship, and those in which it is towed by a waterborne vehicle.

Additional practices include those in which the hydrogen gas is obtained by electrolysis of water. Among these are practices in which wind energy is used to provide the potential for electrolysis and those in which geothermal energy is used to provide that potential.

In another aspect, the invention features a hydrogen-delivery subsystem and an aerostat-recovery subsystem. The hydrogen-delivery subsystem uses a neutral-buoyancy aerostat towed by a towing vehicle to deliver hydrogen gas from a hydrogen-gas producer to a hydrogen-gas consumer. The aerostat-recovery subsystem enables the aerostat to be carried away from the hydrogen-gas consumer on the towing vehicle.

Embodiments include those in which the hydrogen-delivery subsystem includes a filling station configured to cause aerostats to achieve neutral buoyancy by being filled with hydrogen gas at greater than atmospheric pressure, and a coupling station configured to couple the aerostat, which has been filled to neutral buoyancy, to a towing vehicle.

Other embodiments include those in which the aerostat-recovery subsystem includes an unloading station and a loading station. In such embodiments, the unloading station is configured to receive the aerostat and to unload the hydrogen gas and the loading station is configured to load the aerostat into the towing vehicle.

In still other embodiments, the hydrogen-delivery subsystem includes a bundling station that receives the aerostat, along with additional aerostats and forms a bundle of aerostats that are to be towed together by the towing vehicle.

Among there embodiments are those that further include a storage station that receives one or more bundles of aerostats from the bundling station. At the storage station, the bundles are arranged either horizontally or vertically for short-term or long-term storage prior to transport to either a remote location or a nearby location for consumption. Among these are embodiments in which the bundles are stored horizontally at the storage station and those in which the bundles are installed vertically, with the latter offering the advantage of having a smaller footprint per unit of hydrogen stored.

Among the additional embodiments are those in which the aerostat-recovery subsystem includes a folding station that folds the aerostat into a compact form for loading onto the towing vehicle.

The systems and methods described herein have been described in the context of hydrogen gas. However, the principles relied upon depend on the density of the gas being transported relative to that of the medium through which the aerostat moves. Thus, the gas being transported could be any lighter-than air gas or any mixture of gases such that the overall mixture is lighter than air. Such gases are those that have a lower density than air given the same temperature and pressure. Examples of molecules that would result in lighter-than-air gases include compounds such as water vapor, methane, and ammonia as well as neon gas, nitrogen gas, and helium gas.

### BRIEF DESCRIPTION OF THE FIGURES

FIG. 1 shows a transport system for use in delivering hydrogen gas from a hydrogen-gas producer to a hydrogen-gas consumer;

FIG. 2 shows a hydrogen-delivery subsystem of the transport system shown in FIG. 1;

FIG. 3 shows an aerostat-recovery subsystem of the transport system shown in FIG. 1; and

FIG. 4 shows a transport method.

### DETAILED DESCRIPTION

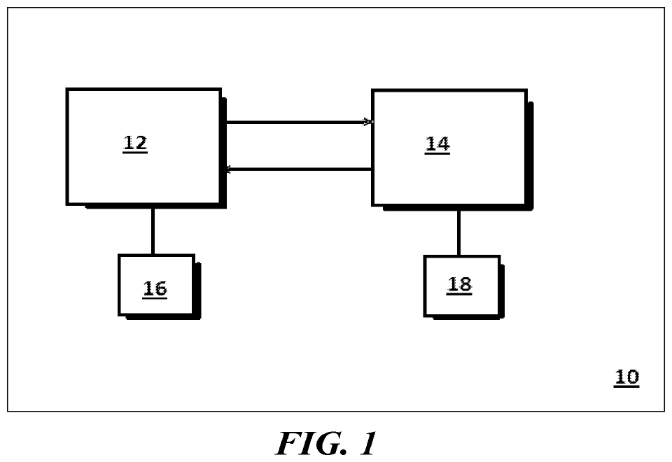

FIG. 1 shows a transport system 10 comprising a hydrogen-delivery subsystem 12 and an aerostat-recovery subsystem 14. These two subsystems 12, 14 cooperate to transport hydrogen gas from a hydrogen-gas producer 16 and a hydrogen-gas consumer 18.

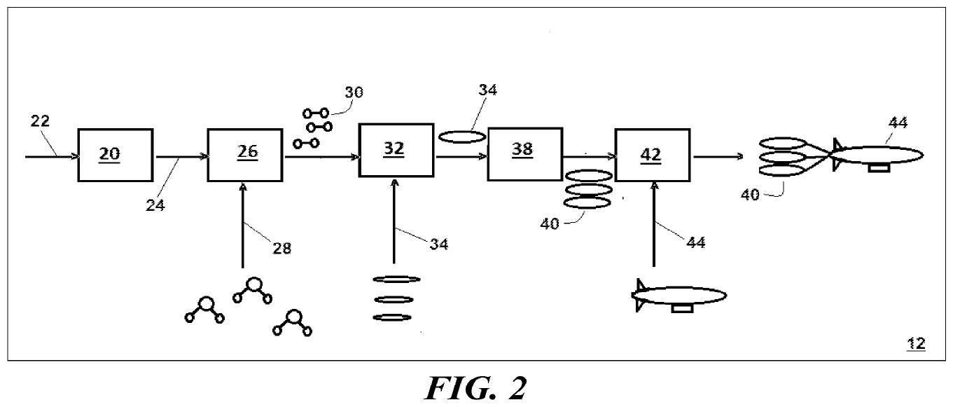

As shown in FIG. 2, the hydrogen-delivery subsystem 12 comprises an energy transformer 20. The energy transformer 20 receives renewable energy 22 and transforms it into electrical energy 24.

Examples of renewable energy 22 include kinetic energy from moving fluid, such as moving air or moving water, as well as thermal energy stored under the Earth's crust. The term “renewable energy” is not intended to imply that energy is somehow renewed or created, as this would appear to be inconsistent with conservation laws. Instead, “renewable energy” is used herein as referring to energy that does not rely on combustion of fossil fuels or nuclear fission.

In the illustrated embodiment, the energy transformer 12 converts kinetic energy from a moving fluid, such as moving air or moving water, into electrical energy. However, in some embodiments, the energy transformer 12 converts heat from geothermal energy into electrical energy 24.

The energy transformer 12 provides the electrical energy 24 to an electrolysis unit 26, which uses it to dissociate water molecules 28 into their respective constituent atoms. This results in formation of hydrogen gas 30 and oxygen gas in a stoichiometrically appropriate ratio.

In a particular embodiment, the energy transformer 12 powers a generator that creates an ac voltage, which is then provided to an ac/dc converter so that a constant potential difference can be imposed between a cathode and anode of the electrolysis unit 26.

The resulting hydrogen gas 30, along with a deflated aerostat 34, is provided to a filling station 32. The deflated aerostat 34 is frameless. As a result, it is possible to fold it.

The filling station 32 fills the aerostat 34 with hydrogen gas 30 until the aerostat 34 reaches a first state of neutral buoyancy. The filling station 32 continues to fill the aerostat 34 with hydrogen gas 30. Eventually, the aerostat 34 reaches its maximum buoyancy. This occurs when the aerostat 34 reaches its maximum volume.

The filling station 32 continues to fill the aerostat 34 with additional hydrogen gas 30. The resulting increase in mass without a concomitant increase in volume causes the aerostat 34 to lose whatever buoyancy it once had. The filling station 32 stops its filling only when the aerostat 34 has returned to a state of neutral buoyancy. The result is a neutrally-buoyant aerostat 36.

The filling station 32 carries out this procedure with multiple deflated aerostats 34. The resulting neutrally-buoyant aerostats 36 are then provided to a bundling station 38 that aligns them and constrains their motion, thereby forming a bundle 40.

The pressure within a neutrally-buoyant aerostat 36 is somewhat high since the mass of hydrogen required to attain neutral buoyancy is high and the volume is fixed. In some cases, the internal pressure is on the order of ten atmospheres. As a result, it is useful for the aerostat 36 to comprise a gas-impermeable bladder, such as one made of stretched polyethylene, and a compressive jacket that applies a radially-inward force to support the bladder against bursting.

A coupling station 42 receives the bundle 40 and couples it to a towing vehicle 44. In the illustrated embodiment, the towing vehicle 44 is a powered aerostat. However, in other embodiments, the towing vehicle 44 is a waterborne vehicle. The towing vehicle 44 tows the resulting bundle 40 to the hydrogen-gas consumer 18. Although the neutrally-buoyant aerostats 36 cannot rise on their own, the velocity of the towing vehicle 44 is sufficient to endow them with dynamic lift. This is because a neutrally buoyant vessel is at a natural tipping point at which only a small amount of lifting force is needed to raise the vessel.

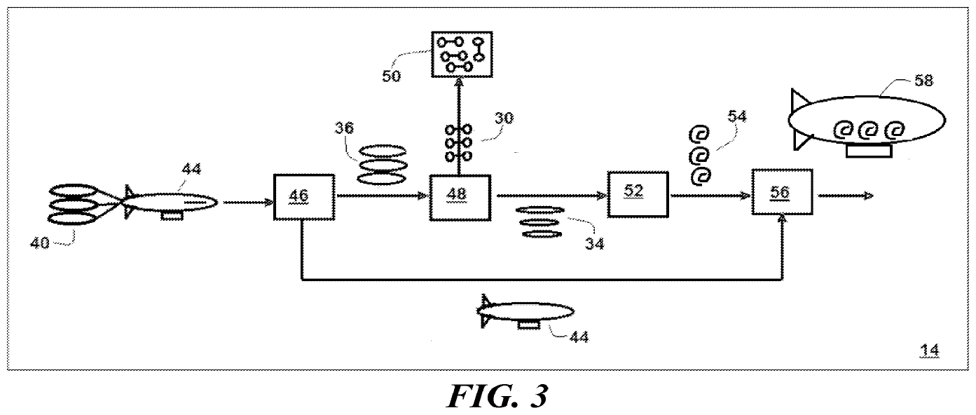

The aerostat-recovery subsystem 14, which is shown in FIG. 3, features a decoupling station 46 that separates the towing vehicle 44 from the bundle 40. The decoupling station 46 provides the bundle 40 to an unloading station 48.

The unloading station 48 separates the bundle 40 into its constituent neutrally-buoyant aerostats 36, removes the hydrogen gas therefrom, and stores it in a storage tank 50. The resulting deflated aerostats 34 are then provided to a folding station 52.

The folding station 52 folds each deflated aerostat 34 into a more compact folded aerostat 54. It then provides the folded aerostats 54 to a loading station 56. The decoupling station 46 will also have provided the towing vehicle 44 to the loading station 56.

At the loading station 56, the folded aerostats 54 are loaded into the towing vehicle 44, thereby forming a loaded towing-vehicle 58. The loaded towing-vehicle 58 then carries the folded aerostats 54 back to the hydrogen-gas producer 16 so that they can be re-used for another delivery of hydrogen gas 30.

In some embodiments, there may exist more than one hydrogen-gas producer 16. Accordingly, the folded aerostats 54 would be delivered to whichever of the hydrogen-gas producers 16 as required based on an as-needed basis.

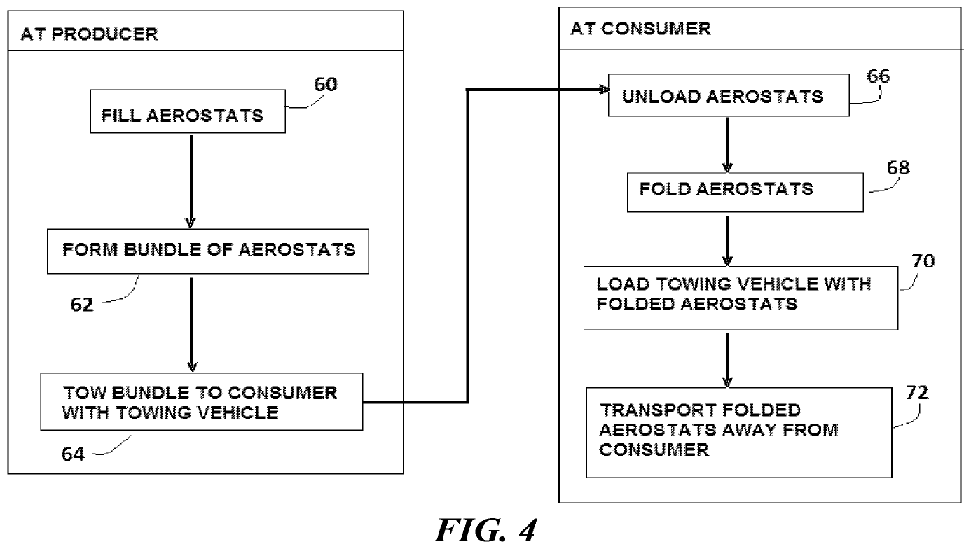

FIG. 4 summarizes a transport method in some detail. The transport method begins at the producer 16 with the steps of filling aerostats 34 (step 60) and forming a bundle 40 of the neutrally-buoyant aerostats 36 (step 62). The bundle 40 is then towed to the consumer 18 (step 64).

At the consumer 18, the neutrally-buoyant aerostats 36 are unloaded (step 66) and folded (step 68). The folded aerostats 54 are then loaded onto the towing vehicle 44 used to tow the aerostats to the consumer 18 (step 70). The towing vehicle 44 then transports the folded aerostats 54 away from the consumer 18 (step 72).

Having described the invention and a preferred embodiment thereof, what is claimed as new and secured by Letters Patent is:

1. A method comprising delivering hydrogen gas from a producer of hydrogen gas to a consumer of hydrogen gas, wherein delivering said hydrogen gas comprises filling an aerostat with said hydrogen gas, thereby causing said aerostat to lose buoyancy and to no longer float, and towing said aerostat to said hydrogen-gas consumer.

2. The method of claim 1, further comprising placing said aerostat inside a towing vehicle that was used to tow said aerostat to said hydrogen-gas consumer and transporting said aerostat away from said hydrogen-gas consumer.

3. The method of claim 1, further comprising folding said aerostat into a form that enables said aerostat to be carried within a towing vehicle that was used to tow said aerostat to said hydrogen-gas consumer.

4. The method of claim 1, wherein said aerostat is one of a plurality of identical aerostats, each of which has lost buoyancy as a result of having been filled with hydrogen gas, wherein delivering said hydrogen gas further comprises bundling said aerostats together, thereby forming a bundle, and wherein towing said aerostat to said hydrogen-gas consumer comprises towing said bundle.

5. The method of claim 1, wherein towing said aerostat to said hydrogen-gas consumer comprises towing said aerostat using a self-propelled aerostat.

6. The method of claim 1, wherein towing said aerostat to said hydrogen-gas consumer comprises towing said aerostat using a waterborne vehicle.

7. The method of claim 1, further comprising obtaining said hydrogen gas through electrolysis of water.

8. The method of claim 1, further comprising using wind-generated electricity to carry out electrolysis of water to extract said hydrogen.

9. The method of claim 1, further comprising using geothermally-generated electricity to carry out electrolysis of water to extract said hydrogen.

10. An apparatus comprising a transport system, said transport system comprising a hydrogen-delivery subsystem that uses a neutral-buoyancy aerostat towed by a towing vehicle to deliver hydrogen gas from a hydrogen-gas producer to a hydrogen-gas consumer and an aerostat-recovery subsystem that enables said aerostat to leave said hydrogen-gas consumer on said towing vehicle.

11. The apparatus of claim 10, wherein said hydrogen-delivery subsystem comprises a filling station configured to cause aerostats to lose buoyancy by filling said aerostats with hydrogen gas and a coupling station configured to couple said aerostat, which has been filled to neutral buoyancy, to a towing vehicle.

12. The apparatus of claim 10, wherein said aerostat-recovery subsystem comprises an unloading station and a loading station, wherein said unloading station is configured to receive said aerostat and to unload said hydrogen gas and wherein said loading station is configured to load said aerostat into said towing vehicle.

13. The apparatus of claim 10, wherein said hydrogen-delivery subsystem comprises a bundling station that receives said aerostat, along with additional aerostats and forms a bundle of aerostats that are to be towed together by said towing vehicle.

14. The apparatus of claim 10, wherein said aerostat-recovery subsystem comprises a folding station that folds said aerostat into a compact form for loading onto said towing vehicle.
